(19) United States
(12) Patent Application Publication
(10) Pub. No.: US 2018/0230390 A1
(43) Pub. Date: Aug. 16, 2018

(54) SLAG MANAGEMENT TOOLSET FOR DETERMINING OPTIMAL GASIFICATION TEMPERATURES

(71) Applicant: United States Department of Energy, Washington, DC (US)

(72) Inventors: Kyei-Sing Kwong, Albany, OR (US); James Bennett, Salem, OR (US)

(21) Appl. No.: 15/894,885

(22) Filed: Feb. 12, 2018

Related U.S. Application Data
(60) Provisional application No. 62/457,249, filed on Feb. 10, 2017.

(51) Int. Cl. C10J 3/84; C10J 3/72; G01N 11/00

(52) U.S. Cl. CPC C10J 3/84; C10J 3/723; C10J 2300/1625; C10J 2300/06; G01N 11/00

(57) ABSTRACT

Embodiments relate to methods, systems and an apparatus for determining an optimal temperature for gasification of a feedstock. The method includes predicting a chemistry of impurities in the feedstock that form a slag; predicting viscosity curves of the impurities in the feedstock that form the slag; predicting a need for one or more additives; and predicting an impact of chemistry changes of the slag based at least partly on temperature vs viscosity behavior during gasification. The method further includes controlling a gasification temperature to achieve a desired viscosity of the slag using at least one of the predicted chemistry changes and the additives.

### CROSS-REFERENCE TO RELATED APPLICATIONS

This application claims the benefit of and priority to U.S. Provisional Application 62/457,249 filed Feb. 10, 2017, which is incorporated herein by reference in its entirety.

### STATEMENT OF GOVERNMENT SUPPORT

The United States Government has rights in this invention pursuant to an employer/employee relationship between the inventors and the U.S. Department of Energy, operators of the National Energy Technology Laboratory (NETL).

### BACKGROUND OF THE INVENTION

Carbon feedstock used in gasification has issues related to mineral and organic-metallic impurities. These impurities melt and coalesce at high gasification temperatures, forming liquid slags of different viscosities depending on ash chemistry, gasification temperature and oxidation partial pressure. Liquid slags may also interact with the gasifier liners, with refractory/slag interactions increasing with increasing temperature. If a slag becomes so viscous that it will not flow from the gasifier, gasifier operators must either increase the gasification temperature to lower slag viscosity so it will flow (causing increased refractory/slag interactions) or shut down the gasifier so the slag can be physically removed from the gasifier, which causes damage to the refractory liner. Refractory liners are needed in the gasifier to protect the metal gasification shell from the gasification process. Knowledge of how to control slag corrosion and viscosity properties is critical to the on-line performance of a gasifier.

Currently feedstock is purchased based on its carbon content, with little attention paid to its impact on gasification operation or refractory service life. Gasifier users currently lack the knowledge to accurately predict the properties of slag formed from a specific feedstock, and how it is compatible with their gasification process—or how to manipulate the feedstock during gasification in relation to controlling or modifying the ash chemistry through slag additives or blending different carbon feedstock materials

Advances are disclosed in the inventors' article entitled A Slag Management Toolset for Determining Optimal Coal Gasification Temperatures (Journal for Manufacturing Science and Production. Volume 16, Issue 4, Pages 233-241 ISSN (Online) 2191-0375, ISSN (Print) 2191-4184) incorporated herein by reference in its entirety.

One or more embodiments of the present invention overcome the above problems.

For a desired gasification temperature range, the slag management toolset enables a user to predict slag viscosity properties and to minimize slag interactions with refractories. The use of slag additives (minerals or process wastes of consistent chemistry) or the blending of different feedstock materials modeled and the chemistry used to predicts lag viscosity before a carbon feedstock is purchased or used in a gasifier—allowing an operator to know the impact of a carbon feedstock slag and any necessary modifications of it on a gasification process, and thus the true cost of using a carbon feedstock. When the slag management toolset is used to control slag chemistry and its impact on a process, it can increase feedstock flexibility, giving a user an indication of a carbon feedstock's impact on gasifier maintenance costs; information that can be used to increase gasifier availability and lower syngas production costs.

The slag management model works by determining the optimal temperature range for gasification of a carbon feedstock using known slag chemistry viscosity vs temperature viscosity properties. The database of the slag chemistry and viscosity information may be expanded to use encrypted proprietary information of the user and his process, allowing slag viscosity predictions to be optimized to a specific user needs.

### SUMMARY

For a desired gasification temperature range, embodiments relate to a slag management toolset enabling users to predict slag viscosity properties and to minimize slag interactions with refractories. The use of slag additives (minerals or process wastes of consistent chemistry) or the blending of different feedstock materials may be predicted and evaluated before a feedstock is purchased or used in a gasifier—allowing an operator to know the impact of a feedstock slag and any necessary modifications of it on a gasification process, and thus the true cost of using a feedstock. When the slag management toolset is used to control slag chemistry and its impact on a process, it can increase feedstock flexibility, giving a user an indication of a feedstock's impact on gasifier maintenance costs; information that can be used to increase gasifier availability and lower syngas production costs.

Embodiments of the slag management model works by determining the optimal temperature range for gasification of a feedstock using known slag chemistry viscosity vs temperature viscosity properties. The database of the slag chemistry and viscosity information may be expanded to use encrypted proprietary information of the user and his process, allowing slag viscosity predictions to be optimized to a specific user needs.

At least one embodiment relates to a method for determining an optimal temperature for gasification of a feedstock. The method includes predicting a chemistry of impurities in the feedstock that form a slag; predicting viscosity curves of the impurities in the feedstock that form the slag; predicting a need for one or more additives; and predicting an impact of chemistry changes of the slag based at least partly on temperature vs viscosity behavior during gasification. The method further includes controlling a gasification temperature to achieve a desired viscosity of the slag using at least one of the predicted chemistry changes and the additives.

Yet one or more other embodiments relate to a method for determining an optimal temperature for gasification of a feedstock in a gasifier, where the gasifier includes at least a refractory liner. The method includes predicting a chemistry of impurities in the feedstock that form a slag; predicting viscosity curves of the impurities in the feedstock that form the slag; predicting a need for one or more additives; and predicting an impact of chemistry changes of the slag based at least partly on temperature vs viscosity behavior during gasification. The method further includes controlling a gasification temperature to achieve a desired viscosity of the slag to preserve the refractory liner integrity using at least one of the predicted chemistry changes and the additives.

Still one or more other embodiments relate to a method for determining an optimal temperature for gasification of a feedstock. The method includes obtaining a first set of rules for predicting a chemistry of impurities in the feedstock that form a slag; obtaining a second set of rules for predicting viscosity curves of the impurities in the feedstock that form the slag; obtaining a third set of rules for predicting a need for one or more additives; and obtaining a fourth set of rules for predicting an impact of chemistry changes of the slag based at least partly on behavior of the temperature vs viscosity during gasification. The method further includes generating a first set of parameters of the chemistry of the impurities using the first set of rules; generating a second set of parameters of viscosity curves of the impurities using the second set of rules; generating a third set of parameters of the need for additives bases on the third set of rules; and generating a fourth set of parameters of the impact of chemistry changes of the slag based at least partly on behavior of the temperature vs viscosity behavior during gasification using the fourth set of rules. The method further includes controlling a gasification temperature to achieve a desired viscosity of the slag using at least the fourth set of parameters and the additives.

Still other embodiments relate to predicting the need for one or more additives comprises predicting a need for an amount or type of additives, where the type of additives comprises slag additives selected from the group comprising minerals and process wastes of consistent chemistry. Embodiments may further may include controlling the gasification temperature to achieve a desired viscosity of the slag comprises selecting the gasification temperature with a temperature high enough to allow the slag to flow and lower than a slag liquidius temperature. Other embodiments may further include predicting the chemistry of the impurities in the feedstock that form the slag, predicting the viscosity curves of the impurities in the feedstock that form the slag; and predicting the need for one or more additives comprises using similar indexes, where using similar indexes includes at least one of silica ratio, optical basicity and non-bridging oxygen atoms and tetrahedrally coordinated atoms (NBO/T). Additional embodiments may include the feedstock comprising at least one of coal, petcoke, biomass and combinations thereof.

Still one or more other embodiments relate to a method for determining an optimal temperature for gasification of a feedstock. The method includes obtaining a first set of rules for predicting a chemistry of impurities in the feedstock that form a slag; obtaining a second set of rules for predicting viscosity curves of the impurities in the feedstock that form the slag; obtaining a third set of rules for predicting a need for one or more additives; and obtaining a fourth set of rules for predicting an impact of chemistry changes of the slag based at least partly on behavior of the temperature vs viscosity during gasification. The method further includes generating a first set of parameters of the chemistry of the impurities using the first set of rules; generating a second set of parameters of viscosity curves of the impurities using the second set of rules; generating a third set of parameters of the need for additives bases on the third set of rules; and generating a fourth set of parameters of the impact of chemistry changes of the slag based at least partly on behavior of the temperature vs viscosity behavior during gasification using the fourth set of rules. The method further includes controlling a gasification temperature to achieve a desired viscosity of the slag using at least the fourth set of parameters and the additives.

Still other embodiments relate to predicting the need for one or more additives comprises predicting a need for an amount or type of additives, where the type of additives comprises slag additives selected from the group comprising minerals and process wastes of consistent chemistry. Embodiments may further may include controlling the gasification temperature to achieve a desired viscosity of the slag comprises selecting the gasification temperature with a temperature high enough to allow the slag to flow and lower than a slag liquidius temperature. Other embodiments may further include predicting the chemistry of the impurities in the feedstock that form the slag, predicting the viscosity curves of the impurities in the feedstock that form the slag; and predicting the need for one or more additives comprises using similar indexes, where using similar indexes includes at least one of silica ratio, optical basicity and non-bridging oxygen atoms and tetrahedrally coordinated atoms (NBO/T). Additional embodiments may include the feedstock comprising at least one of coal, petcoke, biomass and combinations thereof.

### BRIEF DESCRIPTION OF THE DRAWINGS

These and other features, aspects, and advantages of the multiple embodiments of the present invention will become better understood with reference to the following description, appended claims, and accompanied drawings where:

FIG. 1 illustrates a flow chart illustrating the major modeling procedures in accordance with one embodiment of the present invention;

### DETAILED DESCRIPTION OF THE INVENTION

This invention relates to methods, systems and apparatus with respect to a slag management toolset that enables a user to determine the optimal temperature for gasification of a feedstock, such as carbon feedstocks, coal, biomass, petcoke, mixtures thereof and the like, based on the chemistry of mineral and organic-metallic impurities in the carbon feedstock that form slag in the gasifier and the viscosity curves that results from that chemistry prediction/determination. Gasifier operators typically try to keep a gasification temperature within a range for optimal process control. If the gasification temperature is too high, the slag formed from feedstock impurities will be too fluid, typically leading to increased refractory liner corrosion. If the slag temperature is too low, the resulting slag will be very thick (viscous), leading to slag buildup in the gasifier; a situation that can lead to gasifier shutdown if not corrected.

The slag management toolset allows a gasifier operator to control the gasification temperature and achieve a desired viscosity based on slag chemistry and viscosity predictions made by the model. Additives or blending of different carbon feedstocks are made using the slag management model/toolset, which predicts the impact of slag chemistry changes on temperature vs viscosity behavior during gasification.

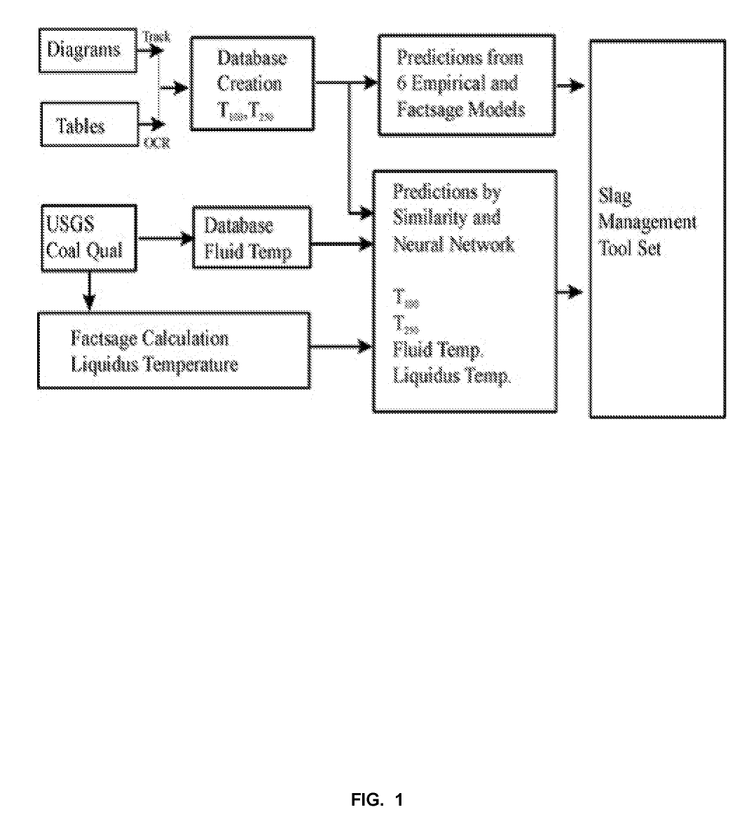

Gasifier operators determine operating temperature by using ash fusion temperature and viscosity characteristics of the ash. The ideal operating temperature should be high enough to allow slag to flow from the gasification chamber between 100 and 250 poises (P), yet at a low enough temperature to minimize refractory corrosion. Refractory liner service life may be improved if the gasifier operating temperature is lower than the slag liquidus temperature, which is defined as the lowest temperature where is slag is completely liquid. The slag liquidus temperature, ash fusion temperature, and viscosity characteristics of the ash are dependent on the slag chemical composition. Slag properties are described using terms like T₂₅₀, and T₁₀₀, which represent the temperatures at which slag viscosity are 250 and 100 poises separately. The slag management toolset is built using “similarity modeling” and databases of viscosity, gasifier ash fusion temperature, and liquidus temperature for predicting slag temperature/viscosity properties based on known slag chemistries in the database. The similarity model is constructed using computer programs that provide expert's opinions (similarity indexes) of known/unknown slag, which are used to decide how similar an unknown slag chemistry is to known slags in the programs database. A suggestion of an operating temperature for a specific slag may be decided by related properties (T₁₀₀, T₂₅₀, fluid temperature, and liquidus temperature) of three nearby similar slags. FIG. 1 illustrates the major modeling procedures. Note this diagram also includes predictions from 6 empirical, FactSage™, and neural network models that were used for making comparisons with the similarity model.

In general; the empirical, neural network, and FactSage™ models use regression methods to analyze their whole (global) available data by a decided equation form (model, such as Arrhenius, Weymann-Frenkel, or other equations). This means the decided equation and whole available data may contribute some prediction errors to local individuals. The similarity model doesn't use regression methods or analyzed global data. It uses only verified expert's opinions and local nearby data. In addition; the empirical, neural network, and FactSage™ models must be repeated for each additional database calculation—the model used are rigid and inflexible, requiring to be reset with each calculation. Some factors/mechanisms may dominate slag viscosity for some sample temperature calculations, but not for others. Globally regression method may introduce prediction errors because they contain unnecessary (or do not contain necessary) mechanisms for assuming the sample chemistries being considered. For example, empirical and FactSage™ models predict slag viscosity properties with the assumption of a 100% molten slag without solids. When the slag contains solids, extra modeling methods are needed to make accurate viscosity predictions. Many models exist commercially or in the literature that predict molten slag viscosity. However, the same model often has different versions that have been created by researchers to optimize its performance for the chemistry range and temperatures being studied, hinting of the uncertainty in these models. It is impossible for gasifier users to decide which model is best for their situation. In addition, experimental results always differ from a given models predictions. The similarity model is very flexible, being able to utilize old and new experimental data. Data from the similarity model includes all mechanisms in the surrounding chemistry range, producing a better representation of the unknown slag chemistry properties. This toolset can also utilize slag information specific to a user's slag practices or carbon feedstock.

### Similarity Models Simulate Expert's Logic Thinking and Observations

Four similarity modeling versions were considered for improving slag modeling predictions/procedures. These procedures are briefly discussed as follows:

1) Similar slags should have similar physical properties: Find a similar slag chemistry to the unknown—then predict a temperature for a specific viscosity from a known calculated knowledge base.

2) Slag having similar physical properties should be similar: Rank the temperatures where a specific constant viscosity occurs, then determine the “best fit regions” using three consecutive samples for predicting the temperature at a specific constant viscosity. The term “best fit regions” is used in order to distinguish the “individual” best fit in algorithm and procedure No. 1.

3) A good prediction will result from similar slags with similar properties: Rank the temperature at a specific constant viscosity; find nearby samples in terms of slag chemistry, then find the best fit region for predicting the temperature at a specific constant viscosity.

4) Use of other models with procedure No. 3: This model uses procedure No. 3 in addition to other similarity indexes; such as silica ratio, optical basicity and NBO/T (terms defined below); that are used. The definition of “regional” is modified by a temperature range (three best fit samples within 50° C.), not a group from three consecutive samples. The range of temperatures at a specific constant viscosity from three consecutive samples in procedures No. 2 and 3 may be any values.

Given the experimental uncertainty and errors during slag viscosity measurements, a group “regional” fit within a reasonable temperature range (within 50° C.) was adopted rather than the individual “best” fit. A regional fit means that three best fit reference samples were selected for making prediction within a range of 50° C. (procedure No. 4) and the best fit regional reference samples are used to yield predictions. The prediction performance was improved using this approach compared with a simple “best” fit prediction of procedure No. 4.

Similarity indexes are used to define the difference between two samples on physical properties or chemistry. These similarity indexes are used in this toolset because published literatures suggested them related to slag viscosity. The formulas of these indexes are shown as follow.

### Chemical Similarity Index

Gasifier slag typically consists of 10 predominant oxides which may be categorized as acidic, amphoteric, or basic; all of which have an influence on slag viscosity. Because of the differing nature of oxides and their influence on slag viscosity, a simplified slag chemical similarity index is defined by the following equation:

ChemSimindex=|Ref_{acid}-Targ_{acid}|+|Refₐₗₗₒ-Targₐₗₗₒ|+|Ref_{base}-Targ_{base}|
Where
Ref=reference samples (samples in the database, except the target sample, which their properties were used to make predictions for the target sample);
Targ=target sample (a sample in which its properties were predicted);
Acid: the total amount of acidic oxides in atomic percentage=SiO₂+TiO₂+SO3+P2O5;
Allo=amphoteric oxide in atomic percentage=Al₂O₃; and
Base=the total amount of basic oxides in atomic percentage=FeO+MgO+CaO+Na2O+K2O+MnO.

### Optical Basicity Index

As provided previously, the optical basicity of a slag is closely related to its viscosity and can be calculated by the following equation and table, which lists the value of optical basicity for oxides used to calculate the optical basicity of a slag.

$$Λ = \frac{\sum {X}_{1} {N}_{1} {Λ}_{th 1} + {X}_{2} {N}_{2} {Λ}_{th 2} + {X}_{3} {N}_{3} {Λ}_{th 3} + Λ}{\sum {X}_{1} {N}_{1} + {X}_{2} {N}_{2} + {X}_{3} {N}_{3} + Λ}$$

Where
X=atomic percentage
N=the number of oxygen atoms in the molecular eg 3 for Al₂O₃
Λth₁=value of the optical basicity of the oxide 1

See K. C. Mills, in Slag Atlas, ed. Verein Deutshcer Eisenhüttenleute (VDEh) 2nd Edition. (D-Düsseldorf German: Verlag Stahleisen mbH, 1995) incorporated herein by reference in its entirety.

TABLE 1

| | Oxide | | | | | | | | | | |
|---|---|---|---|---|---|---|---|---|---|---|---|
| | SiO₂ | Al₂O₃ | FeO | CaO | MgO | K₂O | Na₂O | MnO | TiO₂ | P₂O₅ | SO₃ |
| Optical | 0.48 | 0.6 | 1 | 1.05 | 0.78 | 1.4 | 1.15 | 1 | 0.61 | 0.4 | 0.33 |
| Basicity | | | | | | | | | | | |

### Silica Ratio Index

Following the concept of silica ratio model, the silica ratio is defined by the following equation (in weight percentage)

$$SR = \frac{{SiO}_{2 ( wt \% )}}{( {SiO}_{2} + FeO + MgO + CaO )}$$

SR=Silica Ratio Index

### NBO/T

Gasifier slags contain dominated silica and/or other complex-forming components. The structure of silica is of special interest for understanding the structure and behavior of slags. The degree of depolymerization of silicate melt may be expressed by the ratio of non-bridging oxygen atoms (NBO) and the number of tetrahedrally coordinated atoms (T). This is denoted as NBO/T ratio and the physical properties, such as viscosity, thermal conductivity etc., are very dependent upon the (NBO/T) ratio and it can be calculated by the following procedures:
1) Calculate mole fractions of various constituents; such as X_{SiO2}, X_{Al2O3}, and X_{CaO}
2) Calculate sum of the network formers=X_{T}=Σ(X_{SiO2}+2*X_{Al2O3}+X_{TiO2}+2*X_{P2O5})
3) Determine total charge of network-breaking cation Y1_{NB}=Y1_{NB}=2*(X_{CaO}+X_{MgO}+X_{FeO}+X_{MnO}+X_{Na2O}+X_{K2O})
4) Calculate Y2_{NB} by allowing for the electrical charge balance of AlO₄=Y2_{NB}=Y1_{NB}−2*X_{Al2O3}
5) (NBO/T)=Y2_{NB}/X_{T}
Where
NBOT=non-bridging oxygen atoms (NBO)
T=the number of tetrahedrally coordinated atoms (T)

In order to know which model performs best for the slag chemistry being calculated, an error index was used to define the model's accuracy in ° C.

Error=(Σᵥ₌₅₀^{v=500}|TExp−TMode|)/N
Where:
N=Number of calculation times;
T=Temperature (° C.) at 50-500 P with a step increment of 50 P (P: poise);
Exp=Experiment value;
Model=Prediction value;
V=Constant viscosity

The number of calculations (N) was used because each record may not contain complete slag viscosity measurements from 50 to 500 poises (P).

For clarification, an example demonstrates the similarity procedure No. 4 method necessary to predict T₁₀₀ values for a target sample is listed below:
1) Rank databases by the value of T₁₀₀. In this way, how much similarity exists between two samples in terms of T₁₀₀ may be determined;
2) select nearby reference samples in terms of slag chemistry from the database;
3) extract T₁₀₀ values of nearby reference samples from the database;
4) calculate similarity indexes (such as chemical similarity index, silica ratio, optical basicity, NBO/T and SiO₂ level index) for all nearby reference samples;
5) find the “best fit” three “regional reference” samples;
6) extract the T₁₀₀ values of the three best fit samples from their database set;
7) average the T₁₀₀ values; and
8) output the average value as the predicted T₁₀₀ value for the target sample.

Other properties, such as T₅₀, T₁₅₀, T₂₀₀, . . . , T₅₀₀, liquidus temperature, and fluid temperature, of a target sample may be predicted using the above procedures. Good prediction performance of the similarity model is expected since the best fit three regional reference samples are nearby and have key similar chemical and physical properties (chemical, silica ratio, optical basicity and NBO/T) as the target sample. Similarity model relies on databases and expert's knowledge, and can make direct prediction without studying slag structure (such as quasichemical models) or doing numerical regression fitting for each slag oxide effects (such as empirical models). It is done because similar mechanisms impacting a slag viscosity have already been considered for the reference samples, so would be present in the targeted calculation.

### Performance Accuracy of the Similarity Model Approach

The Tables 2 and 3 illustrate the performance of models (as described by the error index discussed above) for a given slag chemistry. The data indicate that the similarity procedure No. 4 performed the best.

TABLE 2

| Error | | | | Silica | | Watt | |
|---|---|---|---|---|---|---|---|
| (° C.) | Brow-Ning | Urbain | Kalma-Novitch | Ratio | Riboud | Fereday | Factsage ™ |
| 0-40 | 35.88 | 6.87 | 45.04 | 52.29 | 3.05 | 12.98 | 26.56 |
| 40-80 | 21.76 | 24.43 | 22.52 | 20.99 | 10.69 | 31.68 | 18.36 |
| 80-120 | 18.70 | 32.44 | 13.36 | 11.45 | 32.44 | 24.05 | 20.31 |
| >120 | 23.66 | 36.26 | 19.08 | 15.27 | 53.82 | 31.30 | 34.77 |

TABLE 3

| Error | | | | |
|---|---|---|---|---|
| (° C.) | Version 1 | Version 2 | Version 3 | Version 4⁺ |
| 0-40 | 48.24 | 47.66 | 58.78 | 66.1 |
| 40-80 | 23.14 | 27.73 | 22.52 | 16 |
| 80-120 | 16.08 | 11.33 | 8.02 | 9.5 |
| >120 | 12.55 | 13.28 | 10.69 | 8.4 |

Since the different similarity indexes may perform differently predicting slag rheological behavior (such as T₅₀, T₁₀₀, . . . , T₅₀₀), combining results with improved prediction from different indexes together improves the accuracy of similarity model predictions. The following table indicates how these slags' rheological behavior were calculated.

$$For {T}_{50} , {T}_{100} , {T}_{150} and {T}_{200} predictions T = ( {T}_{chem} + {T}_{SR} ) \div 2$$

$$For {T}_{250} , {T}_{300} , {T}_{350} and {T}_{400} T = ( {T}_{chem} + {T}_{OB} ) \div 2$$

$$For {T}_{450} and {T}_{500} T = ( {T}_{chem} + {T}_{OB} + {T}_{NBOT} ) \div 3$$

### Coal Fluidization Temperature and its Use

Ash fusion temperatures are determined by observing the high temperature melting behavior of a ground and molded specimen (test run by ASTM D1857). The ash, in the form of a cone is heated at a defined rate past 1000° C. until the cone melts (but not higher than 1,600° C.). Since the coal ash fusion tests can analyze multiple samples at a time, some gasifier users utilize the fluid temperature obtained from this test to determine the gasifier operating temperature because the test is simple, quick, and economical. However, this test is also subject to a large experimental error because of variations in sample preparation and interpretation of test results.

Table 4 illustrates temperature accuracy predictions of the similarity and other slag models on the a gasifier ash fluid temperature, which is defined by ASTM D1857 as the temperature that the gasifier ash cone has spread to a fused mass no more than 1.6 mm in height. The similarity model used only the slag chemistry similarity index for making prediction. Only a few literature models are shown because not all models could predict the fluid temperature based on the slag chemistry. Various models were compared to predictions of the similarity model, and as show in the Table 4, the similarity model had the most accurate predictions for the slag chemistry evaluated.

TABLE 4

| | Fluid Temperature | | | | |
|---|---|---|---|---|---|
| Error | Similarity | Ozbayoglu's | Ozbayoglu's | Seggini | Seggini |
| (in ° C.) | (%) | Linear | Non-Linear | (1999) | (2003) |
| 0-40 | 55.5 | 6.0 | 4.9 | 26.8 | 27.1 |
| 40-80 | 27.9 | 9.9 | 7.0 | 36.3 | 34.5 |
| 80-120 | 8.2 | 10.9 | 7.0 | 14.8 | 11.6 |
| >120 | 8.1 | 73.2 | 81 | 21.8 | 26.8 |

### Liquidus Temperature

The liquidus temperature is an important parameter when considering the chemical corrosion of refractory linings in a gasifier, and is defined as the lowest temperature where the slag exists in a 100% liquid state. If the gasification temperature is higher than the liquidus temperature, chemical corrosion of the refractory lining is expected because every oxide in the slag is unsaturated. The following Table 5 illustrates the prediction performance of similarity model on liquidus temperature, which only uses the chemical similarity index for making liquidus temperature predictions.

TABLE 5

| Error | Liquidus Temperature - Similarity |
|---|---|
| (in ° C.) | (%) |
| 0-40 | 76.8 |
| 40-80 | 12.3 |
| 80-120 | 4 |
| >120 | 6.8 |

### Determining the Gasification Temperature

As previous discussed, many gasifier operators use slag rheological behavior (T₁₀₀ and T₂₅₀) and gasifier ash fusion temperature to determine the gasification temperature. By adopting the liquidus temperature, gasifier operators can decrease the slag chemically attacking refractory. These four predicted temperatures: T₁₀₀, T₂₅₀, fluid temperature, and liquidus temperature; make complicated situations of deciding the operating temperature. In general, the first step is to decide if a slag liquidus temperature is higher than T₁₀₀, or between T₁₀₀ and T₂₅₀, or less than T₂₅₀. Operating temperature will be designated a different value in various situations. Minor adjustment of operating temperature wills be given with the consideration of fluid temperature, working temperature range, prediction and experimental errors. Generally, the lower the operating temperature, the lower the slag corrosion.

### Laboratory Verification Studies

Six designated artificial slags with/without additives were made and their slag viscosity were measured by a viscometer. The temperatures at which slags viscosity were 100 poises (T₁₀₀) were measured. FactSage™, a thermodynamic computer program, was used to calculate liquidus temperature of these slags (The temperature where no particle solids existed in the slag). The slag management toolset was also used to suggest the operating temperatures for these six slags. Results from the following Table 6 indicate that the slag management toolset can provide a better way of suggesting an operating temperature for gasifier users. Using similarity model predictions, slag should flow smoothly from the gasifier and refractories should have a good operating service life; decreasing gasifier maintenance costs, increasing gasifier availability, widening feedstock flexibility, and allowing gasifier users to predict slag performance in advance.

TABLE 6

| | Mix 1 | Mix 2 | Mix 3 | Mix 4 | Mix 5 | Mix 6 |
|---|---|---|---|---|---|---|
| No additives | | | | | | |
| T₁₀₀ | 1293 | 1403 | 1366 | 1330 | 1391 | 1349 |
| (Experiment) | | | | | | |
| Liquidus | 1314 | 1419 | 1478 | 1352 | 1409 | 1322 |
| (Factsage ™ ) | | | | | | |
| Model | 1331 | 1384 | 1403 | 1331 | 1376 | 1345 |
| Suggestion | | | | | | |
| Suggestion | OK | OK | OK | OK | OK | OK |
| Correctness | | | | | | |
| With Additives | | | | | | |
| T₁₀₀ | 1300 | 1340 | 1360 | 1324 | 1295 | 1281 |
| (Experiment) | | | | | | |
| Liquidus | 1395 | 1439 | 1480 | 1418 | 1389 | 1364 |
| (Factsage ™ ) | | | | | | |
| Model | 1287 | 1345 | 1381 | 1286 | 1354 | 1307 |
| Suggestion | | | | | | |
| Suggestion | OK | OK | OK | NO | OK | OK |
| Correctness | | | | | | |

Similarity modeling has been using in music information retrieval, handwriting, image comparison, and social studies. It has not, however, been used in engineering or material science. This study represents a unique approach to slag modeling and has demonstrated that similarity modeling provides an improved way of accurately predicting molten slag properties based on a data base and a model. It can make slag behavior prediction without studying slag structure (such as quasichemical models) or using regression fitting for each slag oxide effects (such as empirical models) because similar involved mechanisms on slag viscosity already were demonstrated in modeling tests.

Use of the slag management toolset may be expanded to predict slag chemistry properties of viscosity vs temperature in molten oxide slags at high temperature, such as steel slags or the glass industries.

Processes involving control of high temperature slags; such as steel or glass producers, may find the slag management toolbox useful to control slag viscosity during processing of molten materials. Use of the model's approach may be applicable in other industries or processes not related to molten materials, but that are dependent on historical means of process control.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

We claim:

1. A method for determining an optimal temperature for gasification of a feedstock, comprising:
predicting a chemistry of impurities in the feedstock that form a slag;
predicting viscosity curves of the impurities in the feedstock that form the slag;
predicting a need for one or more additives;
predicting an impact of chemistry changes of the slag based at least partly on temperature vs viscosity behavior during gasification; and
controlling a gasification temperature to achieve a desired viscosity of the slag using at least one of the predicted chemistry changes and the additives.

2. The method of claim 1 wherein predicting the need for one or more additives comprises predicting a need for an amount or type of additives.

3. The method of claim 2 wherein the type of additives comprises slag additives selected from the group comprising minerals and process wastes of consistent chemistry.

4. The method of claim 1 wherein controlling the gasification temperature to achieve a desired viscosity of the slag comprises selecting the gasification temperature with a temperature high enough to allow the slag to flow and lower than a slag liquidius temperature.

5. The method of claim 1 wherein predicting the chemistry of the impurities in the feedstock that form the slag, predicting the viscosity curves of the impurities in the feedstock that form the slag; and predicting the need for one or more additives comprises using similar indexes.

6. The method of claim 5 wherein using similar indexes includes at least one of silica ratio, optical basicity and non-bridging oxygen atoms and tetrahedrally coordinated atoms (NBO/T).

7. The method of claim 1 wherein the feedstock comprises at least one of coal, petcoke, biomass and combinations thereof.

8. A method for determining an optimal temperature for gasification of a feedstock in a gasifier, the gasifier comprising at least a refractory liner;
the method comprising:
predicting a chemistry of impurities in the feedstock that form a slag;
predicting viscosity curves of the impurities in the feedstock that form the slag;
predicting a need for one or more additives;
predicting an impact of chemistry changes of the slag based at least partly on temperature vs viscosity behavior during gasification; and
controlling a gasification temperature to achieve a desired viscosity of the slag to preserve the refractory liner integrity using at least one of the predicted chemistry changes and the additives.

9. The method of claim 8 wherein predicting the need for one or more additives comprises predicting a need for an amount or type of additives.

10. The method of claim 9 wherein the type of additives comprises slag additives selected from the group comprising minerals and process wastes of consistent chemistry.

11. The method of claim 8 wherein controlling the gasification temperature to achieve a desired viscosity of the slag comprises selecting the gasification temperature is a temperature high enough to allow the slag to flow and lower than a slag liquidius temperature.

12. The method of claim 8 wherein predicting the chemistry of the impurities in the feedstock that form the slag, predicting the viscosity curves of the impurities in the feedstock that form the slag; and predicting the need for one or more additives comprises using similar indexes.

13. The method of claim 12 wherein using similar indexes includes at least one of silica ratio, optical basicity and non-bridging oxygen atoms and tetrahedrally coordinated atoms (NBO/T).

14. The method of claim 8 wherein the feedstock comprises at least one of coal, petcoke, biomass and combinations thereof.

15. A method for determining an optimal temperature for gasification of a feedstock comprising:
obtaining a first set of rules for predicting a chemistry of impurities in the feedstock that form a slag;
obtaining a second set of rules for predicting viscosity curves of the impurities in the feedstock that form the slag;
obtaining a third set of rules for predicting a need for one or more additives;
obtaining a fourth set of rules for predicting an impact of chemistry changes of the slag based at least partly on behavior of the temperature vs viscosity during gasification;
generating a first set of parameters of the chemistry of the impurities using the first set of rules;
generating a second set of parameters of viscosity curves of the impurities using the second set of rules;
generating a third set of parameters of the need for additives bases on the third set of rules;
generating a fourth set of parameters of the impact of chemistry changes of the slag based at least partly on behavior of the temperature vs viscosity behavior during gasification using the fourth set of rules; and
controlling a gasification temperature to achieve a desired viscosity of the slag using at least the fourth set of parameters and the additives.

16. The method of claim 15 wherein the third set of rules comprises predicting a need for an amount or type of additives.

17. The method of claim 16 wherein the type of additives comprises slag additives selected from the group comprising minerals and process wastes of consistent chemistry.

18. The method of claim 15 wherein controlling the gasification temperature to achieve a desired viscosity of the slag comprises selecting the gasification temperature with a temperature high enough to allow the slag to flow but lower than a slag liquidius temperature.

19. The method of claim 15 wherein the first, second, third and fourth rules comprises using similar indexes.

20. The method of claim 19 wherein using similar indexes includes at least one of silica ratio, optical basicity and non-bridging oxygen atoms and tetrahedrally coordinated atoms (NBO/T).
